(19) United States
(12) Patent Application Publication
(10) Pub. No.: US 2013/0014385 A1
(43) Pub. Date: Jan. 17, 2013

(54) GROUNDING METHOD ADAPTED FOR POWER SUPPLY

(71) Applicants: Ming Xu, Nanjing (CN); Chao Sun, Nanjing (CN)

(72) Inventors: Ming Xu, Nanjing (CN); Chao Sun, Nanjing (CN)

(73) Assignees: FSP-Powerland Technology Inc., Nanjing (CN); FSP TECHNOLOGY INC., Taoyuan County (TW)

(21) Appl. No.: 13/545,985

(22) Filed: Jul. 11, 2012

(30) Foreign Application Priority Data
Jul. 12, 2011 (CN) 201110194453.9

(51) Int. Cl. H01R 43/00

(52) U.S. Cl. 29/825

(57) ABSTRACT

A grounding method adapted for a power supply (for example, an adapter power supply, a three-phase AC-to-DC power supply, a DC-to-DC power supply, . . . , etc., but not limited thereto) is provided, and which includes: (a) providing a circuit body corresponding to the power supply, where the circuit body has an input part and an output part; (b) disposing the circuit body in a shielding layer; and (c) making at least one of the input part and the output part to be coupled with the shielding layer through at least one capacitor. In this case, the present invention can effectively solve the problem of common-mode interferences in the power supply.

### CROSS-REFERENCE TO RELATED APPLICATION

This application claims the priority benefit of China application serial no. 201110194453.9, filed on Jul. 12, 2011. The entirety of the above-mentioned patent application is hereby incorporated by reference herein and made a part of specification.

### BACKGROUND OF THE INVENTION

1. Field of the Invention

The present invention relates to a power supply apparatus, in particular, to a specific method for reducing electromagnetic interferences in a power supply, for example, an adapter power supply, a three-phase AC-to-DC power supply, a DC-to-DC power supply, . . . , etc., but not limited thereto.

2. Description of Related Art

Adopting shielding technologies can effectively suppress electromagnetic radiated interferences in the switch power supply. Shielding technologies are commonly divided into two categories: one is static electricity shielding, and the other is electromagnetic shielding. The static electricity shielding is mainly used for preventing the effects of static electricity field and constant magnetic field, and the electromagnetic shielding is mainly used for preventing effects of alternating electric fields, alternating magnetic fields and alternating electromagnetic fields. In the power supply application, two kinds of shields are presented. One is for the parts of radiating electromagnetic wave, and the other one is for the components affected by electromagnetic waves. In the switch power supply, the components which can radiate electromagnetic waves are transformers, inductors, power elements, etc., and copper plates or iron plates are usually disposed around these components as shields to attenuate electromagnetic waves.

Moreover, in order to suppress the spread of the radiation generated by the switch power supply, and in order to reduce the effects to other electronic equipments by the electromagnetic interferences, overall shielding must be adopted. Shielding shells can be manufactured completely according to the method of shielding magnetic fields, such that the electromagnetic field can be effectively shielded by connecting both the shielding shells and the case of system to the ground.

In order to make the electromagnetic shielding achieve the function of static electricity shielding to enhance shielding effects, and guarantee human and equipment safety, the system should be connected with ground, that is, the grounding technique. Grounding means a path design to establish a conduction between a certain selected point and a certain ground plane in the system. This process is very important because not only the problems of electromagnetic interferences can be effectively solved by correctly connecting the ground with the shielding, but also the anti-interferences capabilities of electronic products can be enhanced.

For example, FIG. 1 illustrates a grounding method for a shielding layer in an adapter power supply in the conventional. Referring to FIG. 1, the conventional adapter power supply includes a circuit body 3 with an input part (L, N) and an output part (41, 42). In this way of connection as shown in FIG. 1, the shielding layer (1) is directly connected with a DC output ground 42, such that the common-mode interference current I_{CM} would flow back to the input part (L, N) through the earth (Z) and LISN (Line Impedance Stabilization Network) resistors, and therefore, the common-mode interference current on the respective LISN resistors can not be attenuated.

### SUMMARY OF THE INVENTION

The present invention provides a new grounding method for a shielding in a power supply to solve the electromagnetic interferences problems of existing technologies.

In order to solve the aforementioned problems, an exemplary embodiment of the present invention provides a grounding method adapted for a power supply. The provided grounding method includes: (a) providing a circuit body corresponding to the power supply, wherein the circuit body has an input part and an output part; (b) providing a shielding layer and disposing the circuit body in the shielding layer; and (c) making at least one of the input part and the output part to be coupled with the shielding layer through at least one capacitor.

In an exemplary embodiment of the present invention, in case that the power supply may be an adapter power supply, the circuit body further includes an input filtering circuit, a rectification circuit, a DC-DC conversion circuit and an output filtering circuit, wherein the input part, the input filtering circuit, the rectification circuit, the DC-DC conversion circuit, the output filtering circuit and the output part are sequentially connected.

In an exemplary embodiment of the present invention, in case that the power supply may be the adapter power supply, the input part is configured to receive an alternative current (AC) power, and includes an L-line and an N-line. The output part is configured to output a direct-current (DC) power, and includes an output positive electrode and an output ground. An input of the DC-DC conversion circuit has a positive terminal and a negative terminal.

In an exemplary embodiment of the present invention, in case that the power supply may be the adapter power supply, the adapter power supply may be an adapter power supplier, and a material of the shielding layer is metal, such that the shielding layer may be one of a case of the adapter power supplier and an element different to the case when the case is made of metal, and the shielding layer is not the case of the adapter power supplier when the case is not made of metal.

In an exemplary embodiment of the present invention, in case that the power supply may be the adapter power supply, the at least one capacitor includes a first safety-certified capacitor and a second safety-certified capacitor, and the step of (c) includes: coupling the L-line and the N-line to the shielding layer; and coupling one of the output positive electrode and the output ground to the shielding layer. In this case, two of the L-line, the N-line and the one of the output positive electrode and the output ground are coupled to the shielding layer through the first safety-certified capacitor and the second safety-certified capacitor respectively, and the remaining one of the L-line, the N-line and the one of the output positive electrode and the output ground is directly coupled to the shielding layer.

In another exemplary embodiment of the present invention, in case that the power supply may be the adapter power supply, the at least one capacitor includes a safety-certified capacitor, and the step of (c) includes: coupling one of the L-line and the N-line to the shielding layer; and coupling one of the output positive electrode and the output ground to the shielding layer. In this case, one of the one of the L-line and the N-line and the one of the output positive electrode and the output ground is coupled to the shielding layer through the safety-certified capacitor, and remaining one of the one of the L-line and the N-line and the one of the output positive electrode and the output ground is directly coupled to the shielding layer.

In another exemplary embodiment of the present invention, in case that the power supply may be the adapter power supply, the at least one capacitor includes a safety-certified capacitor, and the step (c) includes: coupling one of the positive terminal and the negative terminal to the shielding layer; and coupling one of the output positive electrode and the output ground to the shielding layer. In this case, one of the one of the positive terminal and the negative terminal and the one of the output positive electrode and the output ground is coupled to the shielding layer through the safety-certified capacitor, and the remaining one of the one of the positive terminal and the negative terminal and the one of the output positive electrode and the output ground is directly coupled to the shielding layer.

In another exemplary embodiment of the present invention, in case that the power supply may be the adapter power supply, the at least one capacitor includes a first safety-certified capacitor and a second safety-certified capacitor, and the step of (c) includes: coupling the positive terminal and the negative terminal to the shielding layer; and coupling one of the output positive electrode and the output ground to the shielding layer. In this case, two of the positive terminal, the negative terminal and the one of the output positive electrode and the output ground are coupled to the shielding layer through the first safety-certified capacitor and the second safety-certified capacitor respectively, and the remaining one of the positive terminal, the negative terminal and the one of the output positive electrode and the output ground is directly coupled to the shielding layer.

In another exemplary embodiment of the present invention, in case that the power supply may be the adapter power supply, the at least one capacitor includes a safety-certified capacitor. The rectification circuit has a first to a fourth terminals, wherein the first and the second terminals are respectively coupled to the L-line and the N-line through the input filtering circuit, and the third and the fourth terminals are respectively coupled to the positive terminal and the negative terminal. The step of (c) includes: coupling one of the first and the second terminals to the shielding layer; and coupling one of the output positive electrode and the output ground to the shielding layer. In this case, one of the one of the first and the second terminals and the one of the output positive electrode and the output ground is coupled to the shielding layer through the safety-certified capacitor, and remaining one of the one of the first and the second terminals and the one of the output positive electrode and the output ground is directly coupled to the shielding layer.

In an exemplary embodiment of the present invention, in case that the power supply may be a three-phase AC-to-DC power supply, the input part is configured to receive a three-phase AC power, and includes an L1-line, an L2-line, an L3-line and an N-line. The output part is configured to output a DC power, and includes an output positive electrode and an output ground.

In an exemplary embodiment of the present invention, in case that the power supply may be the three-phase AC-to-DC power supply, the three-phase AC-to-DC power supply may be a three-phase AC-to-DC power supplier, and a material of the shielding layer is metal, such that the shielding layer may be one of a case of the three-phase AC-to-DC power supplier and an element different to the case when the case is made of metal, and the shielding layer is not the case of the three-phase AC-to-DC power supplier when the case is not made of metal.

In an exemplary embodiment of the present invention, in case that the power supply may be the three-phase AC-to-DC power supply, the at least one capacitor includes a first safety-certified capacitor, a second safety-certified capacitor, a third safety-certified capacitor and a fourth safety-certified capacitor, and the step of (c) includes: coupling the L1 -line, the L2-line, the L3-line and the N-line to the shielding layer; and coupling one of the output positive electrode and the output ground to the shielding layer. In this case, four of the L1-line, the L2-line, the L3-line, the N-line and the one of the output positive electrode and the output ground are coupled to the shielding layer through the first safety-certified capacitor, the second safety-certified capacitor, the third safety-certified capacitor and the fourth safety-certified capacitor respectively, and the remaining one of the L1-line, the L2-line, the L3-line, the N-line and the one of the output positive electrode and the output ground is directly coupled to the shielding layer.

In an exemplary embodiment of the present invention, in case that the power supply may be a DC-to-DC power supply, the input part is configured to receive a DC input power, and includes an input positive electrode and an input ground. The output part is configured to output a DC output power, and includes an output positive electrode and an output ground.

In an exemplary embodiment of the present invention, in case that the power supply may be the DC-to-DC power supply, the DC-to-DC power supply may be a DC-to-DC power supplier, and a material of the shielding layer is metal, such that the shielding layer may be one of a case of the DC-to-DC power supplier and an element different to the case when the case is made of metal, and the shielding layer is not the case of the DC-to-DC power supplier when the case is not made of metal.

In an exemplary embodiment of the present invention, in case that the power supply may be the DC-to-DC power supply, the at least one capacitor includes a first safety-certified capacitor and a second safety-certified capacitor, and the step of (c) includes: coupling the input positive electrode and the input ground to the shielding layer; and coupling one of the output positive electrode and the output ground to the shielding layer. In this case, two of the input positive electrode, the input ground and the one of the output positive electrode and the output ground are coupled to the shielding layer through the first safety-certified capacitor and the second safety-certified capacitor respectively, and the remaining one of the input positive electrode, the input ground and the one of the output positive electrode and the output ground is directly coupled to the shielding layer.

In an exemplary embodiment of the present invention, each of the above safety-certified capacitors includes a Y1 capacitor or two serially connected Y2 capacitors.

From the above, by adopting the aforementioned strategies submitted by the present invention, the interferences passed out by the power supply (for example, the adapter power supply, the three-phase AC-to-DC power supply, the DC-to-DC power supply, . . . , etc.) can be attenuated. In particular, the common-mode interference currents on the respective LISN resistors can be reduced.

In order to make the aforementioned and other features and advantages of the invention comprehensible, several exemplary implementations accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a grounding method for a shielding layer in an adapter power supply in the conventional.

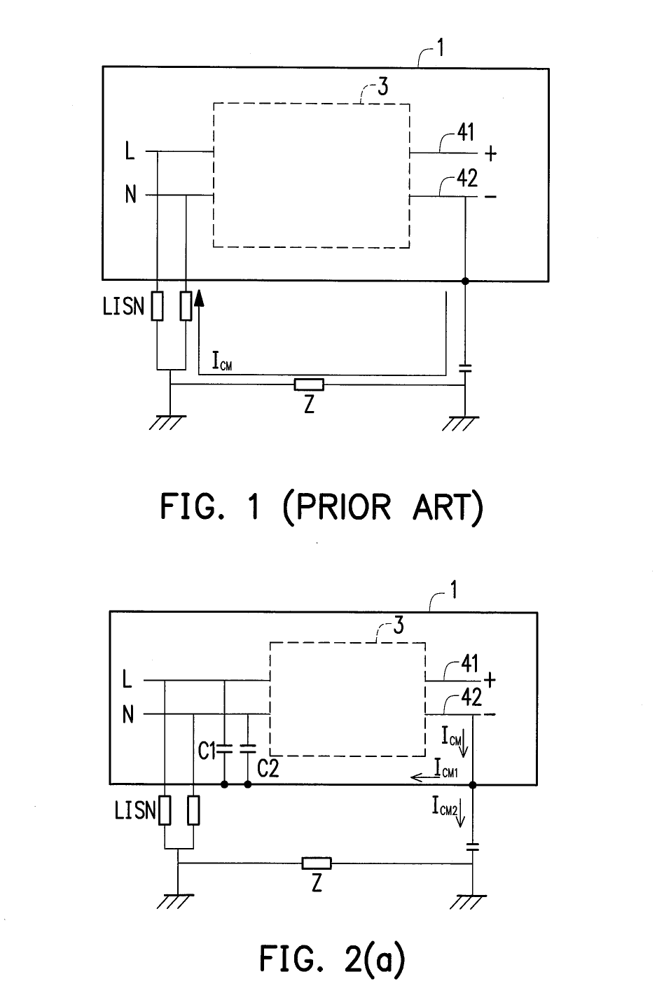

FIG. 2(a) to FIG. 2(f) illustrate a first implementation configuration according to an exemplary embodiment of the present invention.

FIG. 3(a) to FIG. 3(d) illustrate a second implementation configuration according to an exemplary embodiment of the present invention.

FIG. 4(a) to FIG. 4(d) illustrate a third implementation configuration according to an exemplary embodiment of the present invention.

FIG. 5 illustrates a system block diagram of an adapter power supply according to an exemplary embodiment of the present invention.

FIG. 6(a) to FIG. 6(j) illustrate a fourth implementation configuration according to an exemplary embodiment of the present invention.

FIG. 7 is another implementation of FIG. 3(a).

FIG. 8 illustrates a fifth implementation configuration according to an exemplary embodiment of the present invention.

FIG. 9 illustrates a sixth implementation configuration according to an exemplary embodiment of the present invention.

### DETAILED DESCRIPTION OF DISCLOSED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Detailed descriptions of the technical strategies of the present invention will be explained with accompanying drawings.

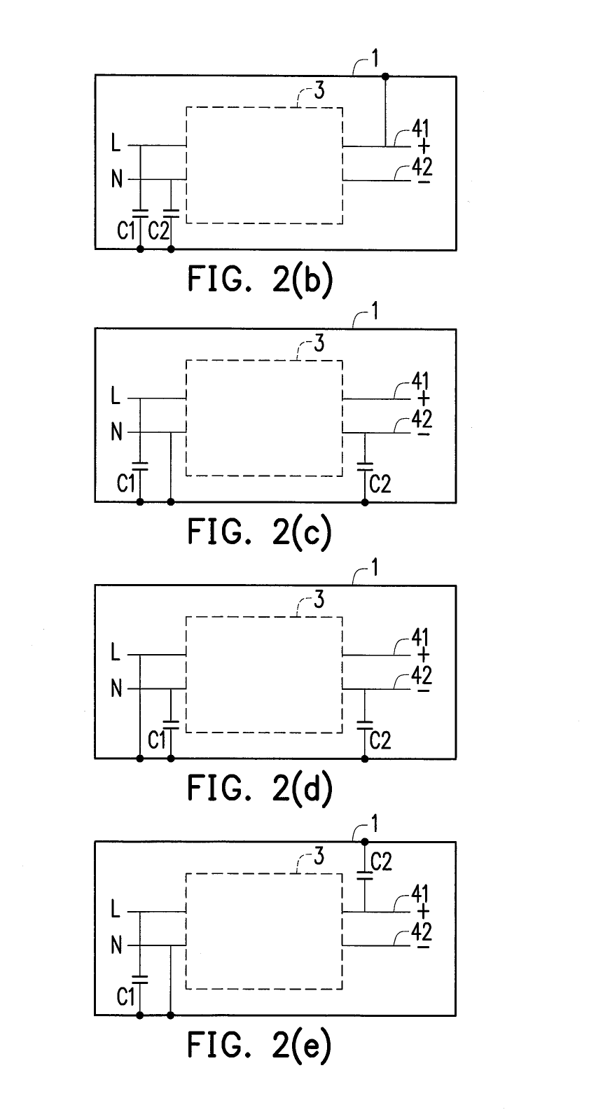

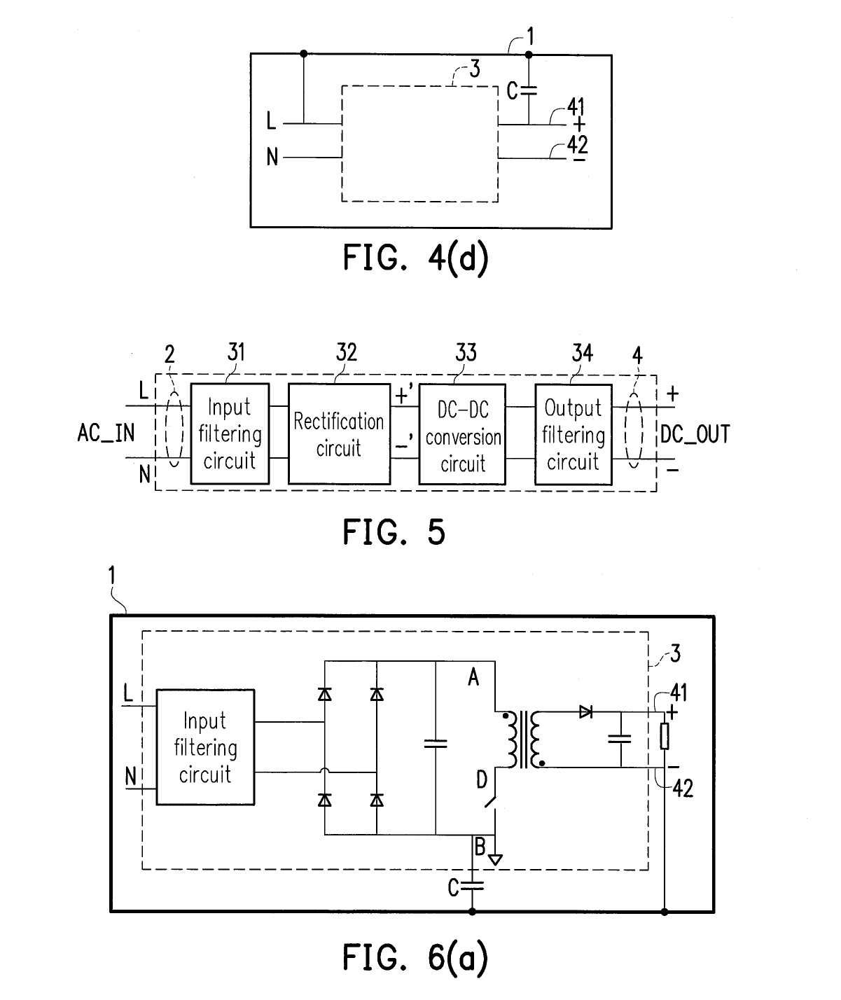

FIGS. 2(a)-2(f) illustrate a first implementation configuration according to an exemplary embodiment of the present invention. Referring to FIGS. 2(a)-2(f), a power supply (for example, an adapter power supply, but not limited thereto) at least includes a shielding layer (1) and a circuit body (3), wherein the adapter power supply may be an adapter power supplier (or an adapter power supply unit), and the material of the shielding layer (1) is metal, for example, copper, iron, etc., but not limited thereto, and also can be called as the shielding shell, such that the shielding layer (1) may be one of a case of the adapter power supply and an element different to the case of the adapter power supplier when the case of the adapter power supplier is made of metal. On the other hand, the shielding layer (1) is not the case of the adapter power supplier when the case of the adapter power supplier is not made of metal. The circuit body (3) includes, as shown in FIG. 5, an input part (2), an input filtering circuit (31), a rectification circuit (32), a DC-DC conversion circuit (33), an output filtering circuit (34) and an output part (4).

In this exemplary embodiment, the input part (2), the input filtering circuit (31), the rectification circuit (32), the DC-DC conversion circuit (33), the output filtering circuit (34) and the output part (4) are sequentially connected. The input part (2) is configured to receive an alternative current (AC) power AC_IN, and includes an L-line (L) and an N-line (N), wherein the L-line (L) can be also called as the fire line, and the N-line (N) can be also called as the neutral line. The output part (4) is configured to output a direct-current (DC) power DC_OUT, and includes an output positive electrode (+, 41) and an output ground (−, 42). An input the DC-DC conversion circuit (33) has a positive terminal (+′) and a negative terminal (−′).

As shown in FIGS. 2(a)-2(f), the L-line (L) and the N-line (N) are coupled to the shielding layer (1), and one of the output positive electrode (+, 41) and the output ground (−, 42) is coupled to the shielding layer (1). And, two of the L-line (L), the N-line (N) and the one of the output positive electrode (+, 41) and the output ground (−, 42) are coupled to the shielding layer (1) through safety-certified capacitors C1, C2 respectively, and the remaining one of the L-line (L), the N-line (N) and the one of the output positive electrode (+, 41) and the output ground (−, 42) is directly coupled to the shielding layer (1).

In FIG. 2(a), for example, the L-line (L) is connected with the shielding layer (1) through the safety-certified capacitor C1. The N-line (N) is connected with the shielding layer (1) through the safety-certified capacitor C2. The output ground (−, 42) is directly connected with the shielding layer (1).

In FIG. 2(b), for example, the L-line (L) is connected with the shielding layer (1) through the safety-certified capacitor C1. The N-line (N) is connected with the shielding layer (1) through the safety-certified capacitor C2. The output positive electrode (+, 41) is directly connected with the shielding layer (1).

In FIG. 2(c), for example, the L-line (L) is connected with the shielding layer (1) through the safety-certified capacitor C1. The N-line (N) is directly connected with the shielding layer (1). The output ground (−, 42) is connected with the shielding layer (1) through the safety-certified capacitor C2.

In FIG. 2(d), for example, the L-line (L) is directly connected with the shielding layer (1). The N-line (N) is connected with the shielding layer (1) through the safety-certified capacitor C1. The output ground (−, 42) is connected with the shielding layer (1) through the safety-certified capacitor C2.

In FIG. 2(e), for example, the L-line (L) is connected with the shielding layer (1) through the safety-certified capacitor C1. The N-line (N) is directly connected with the shielding layer (1). The output positive electrode (+, 41) is connected with the shielding layer (1) through the safety-certified capacitor C2.

In FIG. 2(f), for example, the L-line (L) is directly connected with the shielding layer (1). The N-line (N) is connected with the shielding layer (1) through the safety-certified capacitor C1. The output positive electrode (+, 41) is connected with the shielding layer (1) through the safety-certified capacitor C2.

The principle of FIG. 2(a) is similar to that of FIGS. 2(b)-2(f), so herein, taking FIG. 2(a) as an example to specify the principle of the present invention. By the connection of FIG. 2(a), the common-mode interference current I_{CM} is bypassed by the branch(s) formed between the safety-certified capacitors C1, C2 and the shielding layer (1). Hence the common-mode interference current on the respective LISN resistors is attenuated, such that the detected common-mode interferences are reduced.

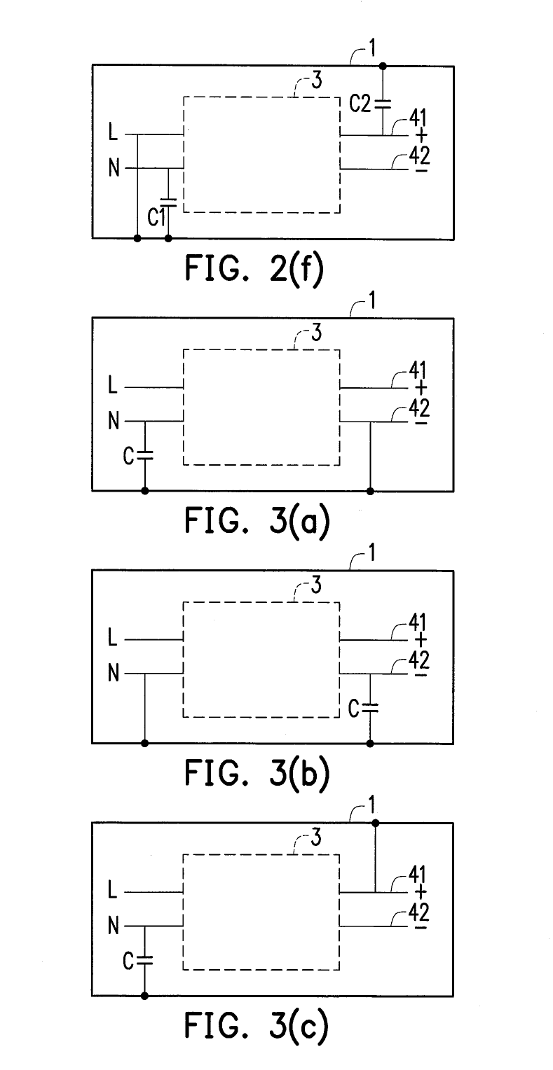

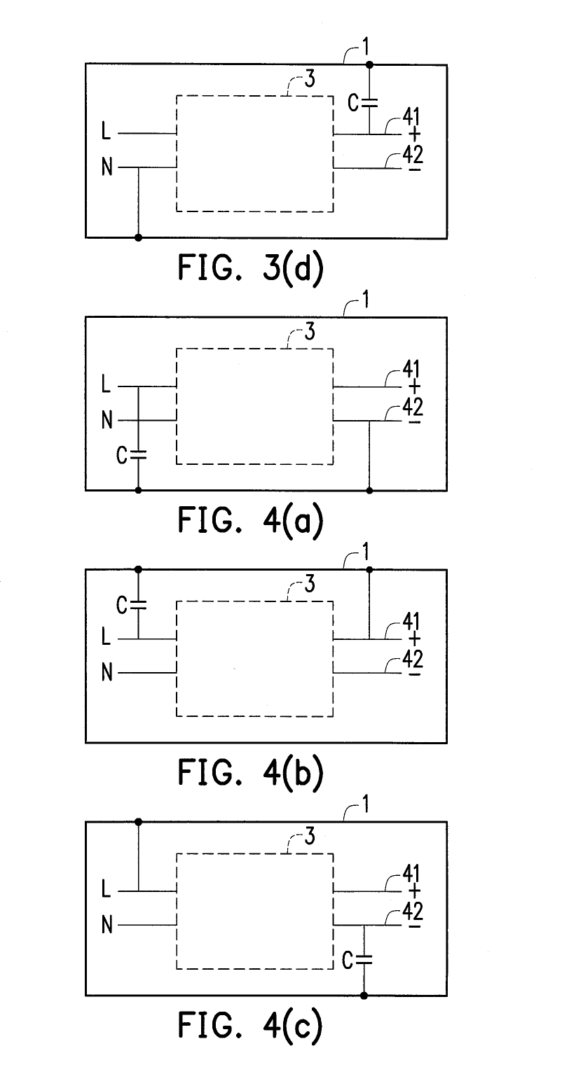

On the other hand, FIGS. 3(a)-3(d) illustrate a second implementation configuration according to an exemplary embodiment of the present invention. FIGS. 4(a)-4(d) illustrate a third implementation configuration according to an exemplary embodiment of the present invention. Referring to FIGS. 3(a)-3(d) and 4(a)-4(d), as shown in FIGS. 3(a)-3(d) and 4(a)-4(d), one of the L-line (L) and the N-line (N) is coupled to the shielding layer (1), and one of the output positive electrode (+, 41) and the output ground (−, 42) is coupled to the shielding layer (1). And, one of the one of the L-line (L) and the N-line (N) and the one of the output positive electrode (+, 41) and the output ground (−, 42) is coupled to the shielding layer (1) through a safety-certified capacitor C, and remaining one of the one of the L-line (L) and the N-line (N) and the one of the output positive electrode (+, 41) and the output ground (−, 42) is directly coupled to the shielding layer (1).

In FIG. 3(a), for example, the N-line (N) is connected with the shielding layer (1) through the safety-certified capacitor C, and the output ground (−, 42) is directly connected with the shielding layer (1).

In FIG. 3(b), for example, the N-line (N) is directly connected with the shielding layer (1), and the output ground (−, 42) is connected with the shielding layer (1) through the safety-certified capacitor C.

In FIG. 3(c), for example, the N-line (N) is connected with the shielding layer (1) through the safety-certified capacitor C, and the output positive electrode (+, 41) is directly connected with the shielding layer (1).

In FIG. 3(d), for example, the N-line (N) is directly connected with the shielding layer (1), and the output positive electrode (+, 41) is connected with the shielding layer (1) through the safety-certified capacitor C.

In FIG. 4(a), for example, the L-line (L) is connected with the shielding layer (1) through the safety-certified capacitor C, and the output ground (−, 42) is directly connected with the shielding layer (1).

In FIG. 4(b), for example, the L-line (L) is connected with the shielding layer (1) through the safety-certified capacitor C, and the output positive electrode (+, 41) is directly connected with the shielding layer (1).

In FIG. 4(c), for example, the L-line (L) is directly connected with the shielding layer (1), and the output ground (−, 42) is connected with the shielding layer (1) through the safety-certified capacitor C.

In FIG. 4(d), for example, the L-line (L) is directly connected with the shielding layer (1), and the output positive electrode (+, 41) is connected with the shielding layer (1) through the safety-certified capacitor C.

The second implementation configuration as shown in FIGS. 3(a)-3(d) and the third implementation configuration as shown in FIGS. 4(a)-4(d) also can achieve the purpose of the first implementation configuration as shown in FIGS. 2(a)-2(f).

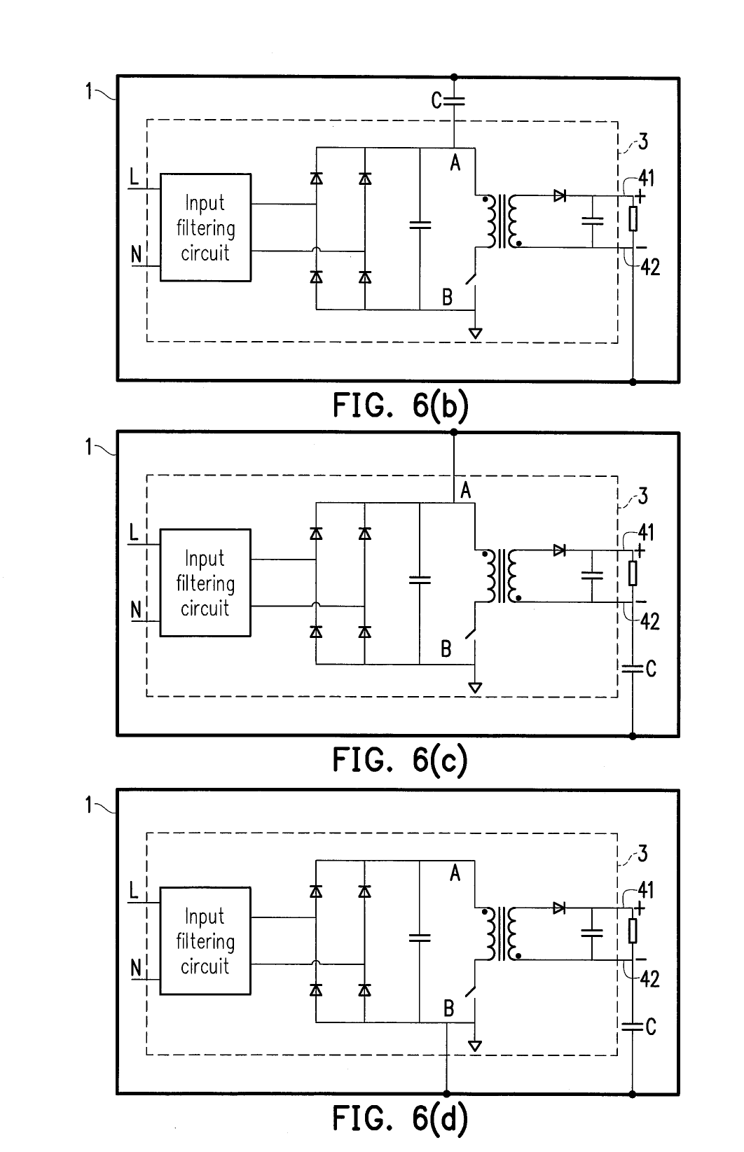

On the other hand, FIGS. 6(a)-6(j) illustrate a fourth implementation configuration according to an exemplary embodiment of the present invention. Referring to FIGS. 6(a)-6(j), in this exemplary embodiment, the rectification circuit (32) as shown in FIGS. 6(a)-6(j) may be implemented by a full-bridge topology, but not limited thereto. In this case, as shown in FIGS. 6(a)-6(d), one of the positive terminal (+′, A) and the negative terminal (−′, B) is coupled to the shielding layer (1), and one of the output positive electrode (+, 41) and the output ground (−, 42) is coupled to the shielding layer (1). And, one of the one of the positive terminal (+′, A) and the negative terminal (−′, B) and the one of the output positive electrode (+, 41) and the output ground (31 , 42) is coupled to the shielding layer (1) through a safety-certified capacitor C, and the remaining one of the one of the positive terminal (+′, A) and the negative terminal (−′, B) and the one of the output positive electrode (+, 41) and the output ground (−, 42) is directly coupled to the shielding layer (1).

In FIG. 6(a), for example, the negative terminal (−′, B) is connected with the shielding layer (1) through the safety capacitor C, and the output ground (−, 42) is directly connected with the shielding layer (1).

In FIG. 6(b), for example, the positive terminal (+′, A) is connected with the shielding layer (1) through the safety capacitor C, and the output ground (−, 42) is directly connected with the shielding layer (1).

In FIG. 6(c), for example, the positive terminal (+′, A) is directly connected with the shielding layer (1), and the output ground (−, 42) is connected with the shielding layer (1) through the safety-certified capacitor C.

In FIG. 6(d), for example, the negative terminal (−′, B) directly connected with the shielding layer (1), and the output ground (−, 42) is connected with the shielding layer (1) through the safety-certified capacitor C.

Of course, in the other exemplary embodiments different from FIGS. 6(a)-6(d), the negative terminal (−′, B) may be directly connected with the shielding layer (1), and the output positive electrode (+, 41) may be connected with the shielding layer (1) through the safety-certified capacitor C; alternatively, the positive terminal (+′, A) may be directly connected with the shielding layer (1), and the output positive electrode (+, 41) is connected with the shielding layer (1) through the safety-certified capacitor C.

In addition, as shown in FIGS. 6(e)-6(j), the positive terminal (+′, A) and the negative terminal (−′, B) are coupled to the shielding layer (1), and one of the output positive electrode (+, 41) and the output ground (−, 42) is coupled to the shielding layer (1). And, two of the positive terminal (+′, A), the negative terminal (−′, B) and the one of the output positive electrode (+, 41) and the output ground (−, 42) are coupled to the shielding layer (1) through safety-certified capacitors C1, C2 respectively, and the remaining one of the positive terminal (+′, A), the negative terminal (−′, B) and the one of the output positive electrode (+, 41) and the output ground (−, 42) is directly coupled to the shielding layer (1).

In FIG. 6(e), for example, the positive terminal (+′, A) and the negative terminal (−′, B) are connected with the shielding layer (1) through the safety-certified capacitors C1, C2 respectively, and the output ground (−, 42) is directly connected with the shielding layer (1).

In FIG. 6(f), for example, the positive terminal (+′, A) and the output ground (−, 42) are connected with the shielding layer (1) through the safety-certified capacitors C1, C2 respectively, and the negative terminal (−′, B) is directly connected with the shielding layer (1).

In FIG. 6(g), for example, the negative terminal (−′, B) and the output ground (−, 42) are connected with the shielding layer (1) through the safety-certified capacitors C1, C2 respectively, and the positive terminal (+′, A) is directly connected with the shielding layer (1).

In FIG. 6(h), for example, the positive terminal (+′, A) and the negative terminal (−′, B) are connected with the shielding layer (1) through the safety-certified capacitors C1, C2 respectively, and the output positive electrode (+, 41) is directly connected with the shielding layer (1).

In FIG. 6(i), for example, the negative terminal (−′, B) and the output positive electrode (+, 41) are connected with the shielding layer (1) through the safety-certified capacitors C1, C2 respectively, and the positive terminal (+′, A) is directly connected with the shielding layer (1).

In FIG. 6(j), for example, the positive terminal (+′, A) and the output positive electrode (+, 41) are connected with the shielding layer (1) through the safety-certified capacitors C1, C2 respectively, and the negative terminal (−′, B) is directly connected with the shielding layer (1).

The fourth implementation configuration as shown in FIGS. 6(a)-6(j) also can achieve the purpose of the first implementation configuration as shown in FIGS. 2(a)-2(f).

For the aforementioned exemplary embodiments relating to the first to the fourth implementation configurations, the provided new grounding manner for the shielding layer (1) in the adapter power supply can directly bypass a part of the common-mode interference current (I_{CM}) back to the input part (2) through at least one safety-certified capacitor. Hence the common-mode interference current on the respective LISN resistors is attenuated.

In the aforementioned first, second and third implementation configurations, the L-line (L) and the N-line (N) are taken for an example to connect with the shielding layer (1), but the invention is not limited thereto. To be specific, the rectification circuit (32) may have terminals L′, N′, A′, B′ each having non-high-frequency variation, wherein the terminals L′, N′ are respectively coupled to the L-line (L) and the N-line (N) through the input filtering circuit (31), and the terminals A′, B′ are respectively coupled to the positive terminal (+′, A) and the negative terminal (−′, B). In this case, one of the terminals L′, N′ is coupled to the shielding layer (1), and one of the output positive electrode (+, 41) and the output ground (−, 42) is coupled to the shielding layer (1). And, one of the one of the terminals L′, N′ and the one of the output positive electrode (+, 41) and the output ground (−, 42) is coupled to the shielding layer (1) through a safety-certified capacitor C, and remaining one of the one of the terminals L′, N′ and the one of the output positive electrode (+, 41) and the output ground (−, 42) is directly coupled to the shielding layer (1).

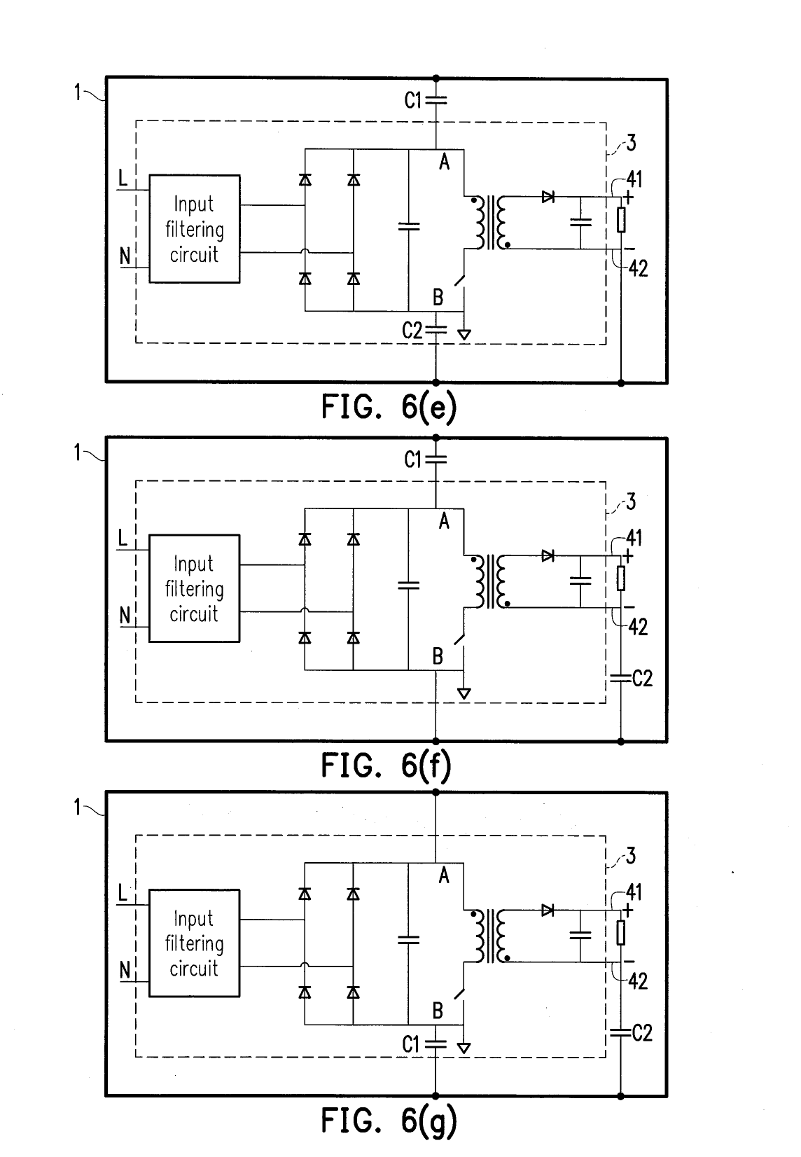

In FIG. 7, for example, the terminal N′ is connected with the shielding layer (1) through the safety-certified capacitor C, and the output ground (−, 42) is directly connected with the shielding layer (1).

Of course, in the other exemplary embodiments different from FIG. 7, the terminal N′ may be directly connected with the shielding layer (1), and the output ground (−, 42) is connected with the shielding layer (1) through the safety-certified capacitor C. Or, the terminal N′ may be connected with the shielding layer (1) through the safety-certified capacitor C, and the output positive electrode (+, 41) is directly connected with the shielding layer (1). Or, the terminal N′ is directly connected with the shielding layer (1), and the output positive electrode (+, 41) is connected with the shielding layer (1) through the safety-certified capacitor C.

Similarly, in the other exemplary embodiments, the terminals L′, N′ also can be replaced by nodes respectively connected with the L-line (L) and the N-line (N) in the input filtering circuit (31).

In addition, in the other exemplary embodiments, the positive terminal (+′, A) and the negative terminal (−′, B) shown in FIGS. 6(a)-6(j) can be replaced by the terminals A′, B′ respectively, excluding terminal D having high-frequency variation.

It should be noted that in the aforementioned exemplary embodiments of the invention, even only the rectifier bridge circuit and the flyback conversion topology are taken as an example, but the invention is not limited thereto. To be specific, the grounding manner provided by the invention is still applicable to other adapter power supplies each having a conversion topology other than the flyback conversion topology, and further applicable to many application fields similar to the adapter power supplies.

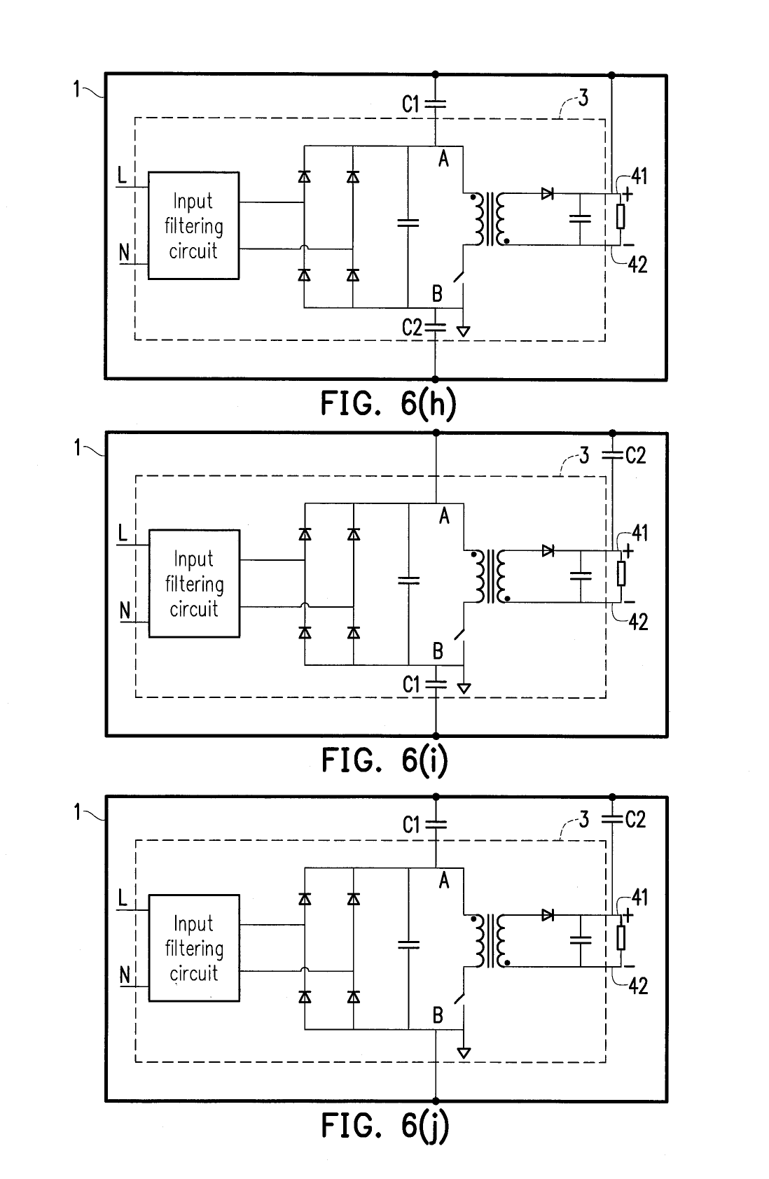

For example, the grounding manner provided by the invention may be applicable to a three-phase AC-to-DC power supply as shown in FIG. 8. Similarly, the three-phase AC-to-DC power supply at least includes a shielding layer (1) and a circuit body (3′), wherein the three-phase AC-to-DC power supply may be a three-phase AC-to-DC power supplier (or a three-phase AC-to-DC power supply unit), and the material of the shielding layer (1) is metal, for example, copper, iron, etc., but not limited thereto, and also can be called as the shielding shell, such that the shielding layer (1) may be one of a case of the three-phase AC-to-DC power supplier and an element different to the case of the three-phase AC-to-DC power supplier when the case of the three-phase AC-to-DC power supplier is made of metal. On the other hand, the shielding layer (1) is not the case of the three-phase AC-to-DC power supplier when the case of the three-phase AC-to-DC power supplier is not made of metal. The circuit body (3′) is corresponding to the three-phase AC-to-DC power supply, and at least includes an input part (2) and an output part (4).

In case that the grounding manner provided by the invention may be applicable to the three-phase AC-to-DC power supply, the input part (2) is configured to receive a three-phase AC power AC_IN′, and includes an L1-line (L_{A}), an L2-line (L_{B}), an L3-line (L_{C}) and an N-line (N), wherein all of the L1-line (L_{A}), the L2-line (L_{B}) and the L3-line (L_{C}) can be also called as the fire lines, and the N-line (N) can be also called as the neutral line. In addition, the output part (4) is configured to output a DC power DC_OUT, and includes an output positive electrode (+, 41) and an output ground (−, 42).

In this exemplary embodiment as shown in FIG. 8, the L1-line (L_{A}), the L2-line (L_{B}), the L3-line (L_{C}) and the N-line (N) are coupled to the shielding layer (1); and one of the output positive electrode (+, 41) and the output ground (−, 42) is coupled to the shielding layer (1). And, four of the L1-line (L_{A}), the L2-line (L_{B}), the L3-line (L_{C}), the N-line (N) and the one of the output positive electrode (+, 41) and the output ground (−, 42) are coupled to the shielding layer (1) through safety-certified capacitors C1, C2, C3, C4 respectively, and the remaining one of the L1-line (L_{A}), the L2-line (L_{B}), the L3-line (L_{C}), the N-line (N) and the one of the output positive (+, 41) electrode and the output ground (−, 42) is directly coupled to the shielding layer (1).

In FIG. 8, for example, the L1-line (L_{A}) is connected with the shielding layer (1) through the safety-certified capacitor C1. The L2-line (L_{B}) is connected with the shielding layer (1) through the safety-certified capacitor C2. The L3-line (L_{C}) is connected with the shielding layer (1) through the safety-certified capacitor C3. The N-line (N) is connected with the shielding layer (1) through the safety-certified capacitor C4. The output positive electrode (+, 41) is directly connected with the shielding layer (1).

Herein, other possible implementation configurations other than FIG. 8 can be inferred/analogized by the teachings of the above exemplary embodiments relating to FIGS. 2(a)-2(f), so the details thereto would be omitted.

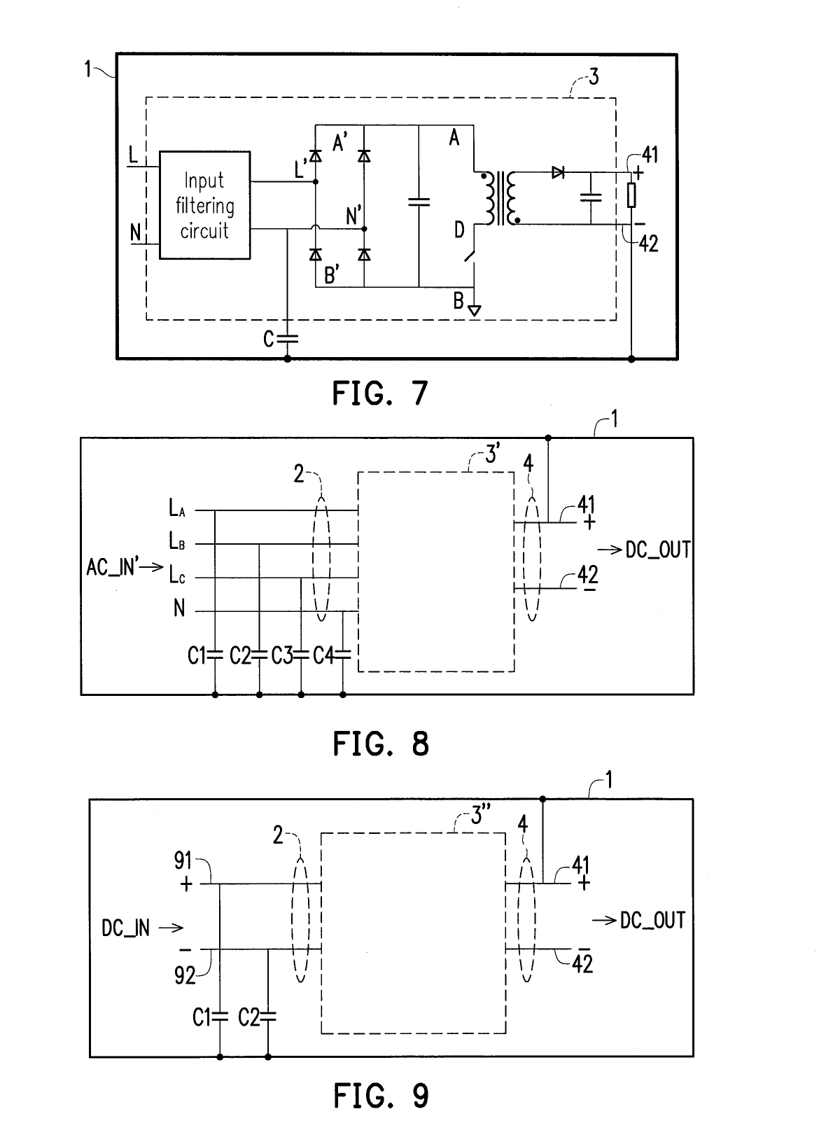

Furthermore, the grounding manner provided by the invention may be applicable to a DC-to-DC power supply as shown in FIG. 9. Similarly, the DC-to-DC power supply at least includes a shielding layer (1) and a circuit body (3″), wherein the DC-to-DC power supply may be a DC-to-DC power supplier (or a DC-to-DC power supply unit), and the material of the shielding layer (1) is metal, for example, copper, iron, etc., but not limited thereto, and also can be called as the shielding shell, such that the shielding layer (1) may be one of a case of the DC-to-DC power supplier and an element different to the case of the DC-to-DC power supplier when the case of the DC-to-DC power supplier is made of metal. On the other hand, the shielding layer (1) is no the case of the DC-to-DC power supplier when the case of the DC-to-DC power supplier is not made of metal. The circuit body (3″) is corresponding to the DC-to-DC power supply, and at least includes an input part (2) and an output part (4).

In case that the grounding manner provided by the invention may be applicable to the DC-to-DC power supply, the input part (2) is configured to receive a DC input power DC_IN, and includes an input positive electrode (+, 91) and an input ground (−, 92). In addition, the output part (4) is configured to output a DC output power DC_OUT, and includes an output positive electrode (+, 41) and an output ground (−, 42).

In this exemplary embodiment as shown in FIG. 9, the input positive electrode (+, 91) and the input ground (−, 92) are coupled to the shielding layer (1), and one of the output positive electrode (+, 41) and the output ground (31 42) is coupled to the shielding layer (1). And, two of the input positive electrode (+, 91), the input ground (−, 92) and the one of the output positive electrode (+, 41) and the output ground (−, 42) are coupled to the shielding layer (1) through safety-certified capacitors C1, C2 respectively, and the remaining one of the input positive electrode (+, 91), the input ground (−, 92) and the one of the output positive electrode (+, 41) and the output ground (−, 42) is directly coupled to the shielding layer (1).

In FIG. 9, for example, the input positive electrode (+, 91) is connected with the shielding layer (1) through the safety-certified capacitor C1. The input ground (−, 92) is connected with the shielding layer (1) through the safety-certified capacitor C2. The output positive electrode (+, 41) is directly connected with the shielding layer (1).

Herein, other possible implementation configurations other than FIG. 9 can be inferred/analogized by the teachings of the above exemplary embodiments relating to FIGS. 2(a)-2(f), so the details thereto would be omitted.

On the other hand, each of the aforementioned safety-certified capacitors (C, C1, C2, C3, C4) can be a Y1 capacitor, or be equivalent to two serially connected Y2 capacitors, but not limited thereto.

Besides, based on the disclosure/teaching of the above exemplary embodiments, a general grounding method can be summarized and submitted for a power supply, for example, an adapter power supply, a three-phase AC-to-DC power supply, a DC-to-DC power supply, . . . , etc., but not limited thereto. To be specific, the grounding method includes the steps of: (a) providing a circuit body corresponding to the power supply, wherein the circuit body has an input part and an output part; (b) providing a shielding layer and disposing the circuit body in the shielding layer; and (c) making at least one of the input part and the output part to be coupled with the shielding layer through at least one capacitor.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A grounding method, adapted for a power supply, the grounding method comprising:
(a) providing a circuit body corresponding to the power supply, wherein the circuit body has an input part and an output part;
(b) providing a shielding layer and disposing the circuit body in the shielding layer; and
(c) making at least one of the input part and the output part to be coupled with the shielding layer through at least one capacitor.

2. The grounding method as claimed in claim 1, wherein the power supply is an adapter power supply.

3. The grounding method as claimed in claim 2, wherein the circuit body further comprises an input filtering circuit, a rectification circuit, a DC-DC conversion circuit and an output filtering circuit,
wherein the input part, the input filtering circuit, the rectification circuit, the DC-DC conversion circuit, the output filtering circuit and the output part are sequentially connected.

4. The grounding method as claimed in claim 3, wherein
the input part is configured to receive an alternative current (AC) power, and comprises an L-line and an N-line;
the output part is configured to output a direct-current (DC) power, and comprises an output positive electrode and an output ground; and
an input of the DC-DC conversion circuit has a positive terminal and a negative terminal.

5. The grounding method as claimed in claim 4, wherein
the adapter power supply is an adapter power supplier, and a material of the shielding layer is metal; and
the shielding layer is one of a case of the adapter power supplier and an element different to the case when the case is made of metal, and the shielding layer is not the case of the adapter power supplier when the case is not made of metal.

6. The grounding method as claimed in claim 5, wherein the at least one capacitor comprises a first safety-certified capacitor and a second safety-certified capacitor, and the step of (c) comprises:
coupling the L-line and the N-line to the shielding layer; and
coupling one of the output positive electrode and the output ground to the shielding layer,
wherein two of the L-line, the N-line and the one of the output positive electrode and the output ground are coupled to the shielding layer through the first safety-certified capacitor and the second safety-certified capacitor respectively, and the remaining one of the L-line, the N-line and the one of the output positive electrode and the output ground is directly coupled to the shielding layer.

7. The grounding method as claimed in claim 6, wherein each of the first and the second safety-certified capacitors includes a Y1 capacitor or two serially connected Y2 capacitors.

8. The grounding method as claimed in claim 5, wherein the at least one capacitor comprises a safety-certified capacitor, and the step of (c) comprises:
coupling one of the L-line and the N-line to the shielding layer; and
coupling one of the output positive electrode and the output ground to the shielding layer,
wherein one of the one of the L-line and the N-line and the one of the output positive electrode and the output ground is coupled to the shielding layer through the safety-certified capacitor, and remaining one of the one of the L-line and the N-line and the one of the output positive electrode and the output ground is directly coupled to the shielding layer.

9. The grounding method as claimed in claim 8, wherein the safety-certified capacitor includes a Y1 capacitor or two serially connected Y2 capacitors.

10. The grounding method as claimed in claim 5, wherein the at least one capacitor comprises a safety-certified capacitor, and the step (c) comprises:
coupling one of the positive terminal and the negative terminal to the shielding layer; and
coupling one of the output positive electrode and the output ground to the shielding layer,
wherein one of the one of the positive terminal and the negative terminal and the one of the output positive electrode and the output ground is coupled to the shielding layer through the safety-certified capacitor, and the remaining one of the one of the positive terminal and the negative terminal and the one of the output positive electrode and the output ground is directly coupled to the shielding layer.

11. The grounding method as claimed in claim 10, wherein the safety-certified capacitor includes a Y1 capacitor or two serially connected Y2 capacitors.

12. The grounding method as claimed in claim 5, wherein the at least one capacitor comprises a first safety-certified capacitor and a second safety-certified capacitor, and the step of (c) comprises:
coupling the positive terminal and the negative terminal to the shielding layer; and
coupling one of the output positive electrode and the output ground to the shielding layer,
wherein two of the positive terminal, the negative terminal and the one of the output positive electrode and the output ground are coupled to the shielding layer through the first safety-certified capacitor and the second safety-certified capacitor respectively, and the remaining one of the positive terminal, the negative terminal and the one of the output positive electrode and the output ground is directly coupled to the shielding layer.

13. The grounding method as claimed in claim 12, wherein each of the first and the second safety-certified capacitors includes a Y1 capacitor or two serially connected Y2 capacitors.

14. The grounding method as claimed in claim 5, wherein
the at least one capacitor comprises a safety-certified capacitor;
the rectification circuit has a first to a fourth terminals, wherein the first and the second terminals are respectively coupled to the L-line and the N-line through the input filtering circuit, and the third and the fourth terminals are respectively coupled to the positive terminal and the negative terminal; and
the step of (c) comprises:
coupling one of the first and the second terminals to the shielding layer; and
coupling one of the output positive electrode and the output ground to the shielding layer,
wherein one of the one of the first and the second terminals and the one of the output positive electrode and the output ground is coupled to the shielding layer through the safety-certified capacitor, and remaining one of the one of the first and the second terminals and the one of the output positive electrode and the output ground is directly coupled to the shielding layer.

15. The grounding method as claimed in claim 14, wherein the safety-certified capacitor includes a Y1 capacitor or two serially connected Y2 capacitors.

16. The grounding method as claimed in claim 1, wherein the power supply is a three-phase AC-to-DC power supply.

17. The grounding method as claimed in claim 16, wherein
the input part is configured to receive a three-phase AC power, and comprises an L1-line, an L2-line, an L3-line and an N-line; and
the output part is configured to output a DC power, and comprises an output positive electrode and an output ground.

18. The grounding method as claimed in claim 17, wherein
the three-phase AC-to-DC power supply is a three-phase AC-to-DC power supplier, and a material of the shielding layer is metal; and
the shielding layer is one of a case of the three-phase AC-to-DC power supplier and an element different to the case when the case is made of metal, and the shielding layer is not the case of the three-phase AC-to-DC power supplier when the case is not made of metal.

19. The grounding method as claimed in claim 18, wherein the at least one capacitor comprises a first safety-certified capacitor, a second safety-certified capacitor, a third safety-certified capacitor and a fourth safety-certified capacitor, and the step of (c) comprises:
coupling the L1-line, the L2-line, the L3-line and the N-line to the shielding layer; and
coupling one of the output positive electrode and the output ground to the shielding layer,
wherein four of the L1-line, the L2-line, the L3-line, the N-line and the one of the output positive electrode and the output ground are coupled to the shielding layer through the first safety-certified capacitor, the second safety-certified capacitor, the third safety-certified capacitor and the fourth safety-certified capacitor respectively, and the remaining one of the L1-line, the L2-line, the L3-line, the N-line and the one of the output positive electrode and the output ground is directly coupled to the shielding layer.

20. The grounding method as claimed in claim 19, wherein each of the first through the fourth safety-certified capacitors includes a Y1 capacitor or two serially connected Y2 capacitors.

21. The grounding method as claimed in claim 1, wherein the power supply is a DC-to-DC power supply.

22. The grounding method as claimed in claim 21, wherein
the input part is configured to receive a DC input power, and comprises an input positive electrode and an input ground; and
the output part is configured to output a DC output power, and comprises an output positive electrode and an output ground.

23. The grounding method as claimed in claim 22, wherein
the DC-to-DC power supply is a DC-to-DC power supplier, a material of the shielding layer is metal; and
the shielding layer is one of a case of the DC-to-DC power supplier and an element different to the case when the case is made of metal, and the shielding layer is not the case of the DC-to-DC power supplier when the case is not made of metal.

24. The grounding method as claimed in claim 23, wherein the at least one capacitor comprises a first safety-certified capacitor and a second safety-certified capacitor, and the step of (c) comprises:
coupling the input positive electrode and the input ground to the shielding layer; and
coupling one of the output positive electrode and the output ground to the shielding layer,
wherein two of the input positive electrode, the input ground and the one of the output positive electrode and the output ground are coupled to the shielding layer through the first safety-certified capacitor and the second safety-certified capacitor respectively, and the remaining one of the input positive electrode, the input ground and the one of the output positive electrode and the output ground is directly coupled to the shielding layer.

25. The grounding method as claimed in claim 24, wherein each of the first and the second safety-certified capacitors includes a Y1 capacitor or two serially connected Y2 capacitors.
